(19) United States
(12) Patent Application Publication
(10) Pub. No.: US 2022/0178344 A1
(43) Pub. Date: Jun. 9, 2022

(54) Device for Transmitting a Linear Movement To a Rotating Movement

(71) Applicant: Erik Andre Wickman, Arendal (NO)

(72) Inventor: Erik Andre Wickman, Arendal (NO)

(21) Appl. No.: 17/437,015

(22) PCT Filed: Mar. 9, 2020
(86) PCT No.: PCT/NO2020/050064

§ 371 Date: Sep. 7, 2021

(30) Foreign Application Priority Data
Mar. 7, 2019 (NO) 20190305

(51) Int. Cl. F03B 13/18; F03B 13/20; F16H 19/04; F16H 55/26

(52) U.S. Cl. CPC F03B 13/186; F03B 13/20; F05B 2250/72; F16H 55/26; F16H 19/04

(57) ABSTRACT

The invention relates to a device for converting a linear motion into a rotary motion, wherein the device comprises a cylindrical pile rack, with teeth axially arranged around the entire pile throughout its longitudinal axis, and at least one gearbox comprising four gear wheels rotatably arranged around their own axis of rotation perpendicular to the centre axis of the pile rack and engaging in the pile of a first plane, the gear wheels having arcuate teeth and adapted to the radius of the pile and wherein the gearbox with the gears is further rotatably arranged around the centre axis of the pile rack so that the gear wheels guide and centre the pile rack as the gearbox moves linearly with respect to the pile rack and/or about the pile rack.

### BACKGROUND

The present invention relates to a device for converting a linear motion to a rotary motion, in particular for use in a wave power plant.

There are today a number of types of wave power plants, and common to several of these, the power plant is driven by floating systems that move mainly vertically linearly in the sea. Through this vertical linear motion, energy can be transferred to power production. This can be through direct linear power generation, or where the linear motion is transferred into a rotary motion with rack and pinion to one or more generator(s).

Examples of technology based on this latter solution can be found in EP 3456956 A1.

A current technique is found in patent application CN 201092928 which discloses an invention which relates primarily to a wave power device comprising a hollow floating ball body, a gearbox, an annular toothed column, a commutator, a speed changer, a stepless gear and a motor.

Another current technique is disclosed in U.S. Patent Application No. 2273602 which discloses a mechanism for motion transfer.

Other relevant techniques are disclosed in patent applications U.S. Pat. No. 3,218,875, JP S55132460, DE 2431402, WO 2016179047, DE 102009039214 and JP H06171577.

### SUMMARY OF THE INVENTION

It is an object of the present invention to provide a device for transferring linear motion energy to a gear system or vice versa. The system can be used in a wave power plant but is not limited to this. The device provides a robust and flexible energy transfer system where motion energy can be transferred in three planes (X, Y, Z) and thus cover a desirable volume range.

In a preferred embodiment, the invention relates to a device for converting linear motions to rotary motions in that the device comprises a cylindrical pile rack with teeth axially arranged around the whole pile rack and all or part of its longitudinal axis, and at least one gearbox which in turn comprises four gear wheels which are rotatably arranged around their own axis of rotation and lying perpendicular to the centre axis of the pile rack. At the same time, they are engaging in the teeth of the pile rack in a first plane, the gear wheels having teeth which are arcuate and adapted to the radius of the pile rack. The gear wheels are further rotatably arranged around the centre axis of the pile rack to be able to guide and centre the pile rack as the gearbox moves linearly with respect to the pile rack and/or around the pile rack.

In a second embodiment, the pile rack is divided radially into at least two parts and interconnected, where the interlocking provides a seamless and continuous pile rack. The coupling can typically be conical convex at one coupling end (male) and fit into a corresponding conical concave coupling end (female).

In a third embodiment, the above-mentioned gearbox also comprises at least two gear wheels pivotally disposed about their own rotational axis and engaging the pivot gear in a second plane of the gearbox.

In a fourth embodiment, the gearbox further comprises several sets of at least two gear wheels also rotatably arranged around their own rotational axis and engaging in the multi-plane pile rack.

In a fifth embodiment, all the teeth of the afore-mentioned pile rack are further comprised of radially arranged and evenly spaced gear wheels grooved in the afore mentioned axially arranged teeth and the grooves run parallel to the centre axis of the pile rack in whole or part of its length.

In a sixth embodiment, the gearbox is further comprised of at least one elongated gear wheel arranged in a spaced plane with its axis of rotation parallel to the centre axis of the pile rack and forming a planetary gear with the pile rack. The elongated gear wheel will be engaged in at least one of the pile rack teeth. In this technical embodiment, the gearbox will be able to rotate in controlled movements around the pile rack, while also being able to move controlled in the axial direction of the pile rack.

In a seventh embodiment, the device is comprised of a pile rack with two engaged gearboxes.

In an eighth embodiment, the gear wheels in the gearbox(es) mentioned above are connected by one or more propellants. These may be wheel axles, angular joints, angled gears, gear sets, chain or other known mechanical systems suitable for transmitting power between gear wheels in line or at an angle to each other.

In a ninth embodiment, the gear wheels of the gearbox(es) are each coupled with at least one generator and/or at least one motor.

In a tenth embodiment, the device is connected to a floating element for use in a wave power plant. The floating element together with the gearbox will also be able to rotate around the centre axis of the pile rack at the same time as the vertical movement. Energy will be transmitted via a vertically-directed force from the floating element via the pile rack, through the gearbox and directly onto generators. These are either encased/embedded in the floating element or enclosed above or below the floating element.

In an eleventh embodiment, at least one of said gearbox(es) is fixedly mounted in the above-mentioned floating element with gear exchange to generators.

In a twelfth embodiment, the energy transmitted via the gearbox is transmitted to gears, shafts, pressure systems, hydraulics, or chain drives, or other known mechanical systems suitable for power transmission between gears in line or at an angle to each other.

In a thirteenth embodiment, said rods are anchored and firmly connected to a seabed, or to any fixed element.

In a fourteenth embodiment, at least one gearbox is mounted in, on or below the above-mentioned floating element.

In a fifteenth embodiment, the float element is comprised of a coupling against a gyro in a first side and which is further coupled to a gearbox in a second side.

This is achieved with a device and wave power plant as is apparent from the following claims.

### BRIEF DESCRIPTION OF THE DRAWINGS

The invention will now be described in detail with reference to the accompanying drawings, in which

FIG. 1 is a top view of the gearbox and pile rack.

FIG. 2 shows a side view of the gearbox.

FIG. 3 illustrates the invention in an embodiment with a wave-stressed floating element.

FIG. 4 is a perspective view of a gearbox and pile rack.

FIG. 5 shows a gearbox with built-in gyro balancing.

FIG. 6 shows a pile rack adapted for gear engagement in both vertical direction and horizontal direction.

FIG. 7 shows two pile racks engaged in a gearbox.

FIG. 8 shows a two-piece pile rack with a gearbox.

### DETAILED DESCRIPTION OF THE INVENTION

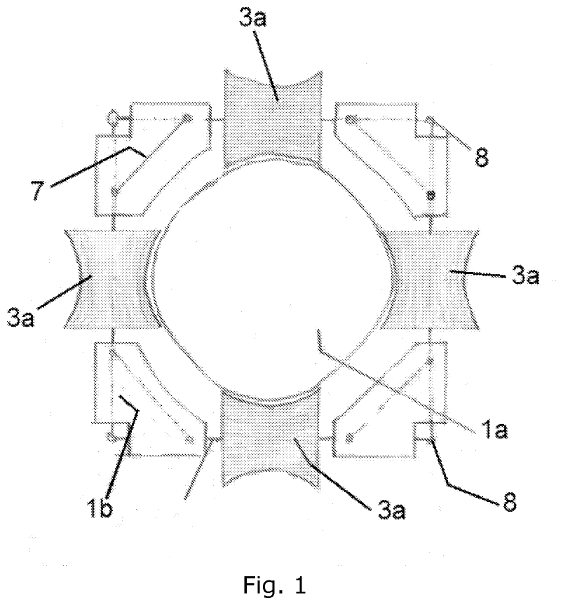

FIG. 1 shows in a view a pile rack la, surrounded by a gearbox lb with four gearwheels 3a, the teeth being arcuate in their circumference and adapted for optimal engagement with said pile rack 1. The gearbox is thus centred relative to the vertical centre axis of the pile rack. The gearwheels 3a are each fixed to the gearbox 2 by means of a through shaft which is fixedly fixed to the gearbox and each gearwheel having at least one rotating bearing.

Further, the gearwheels 3a of the gearbox lb are connected by one or more means 7, 8 selected from: the wheel axles, angular joints, angled gears, gears, cardan,

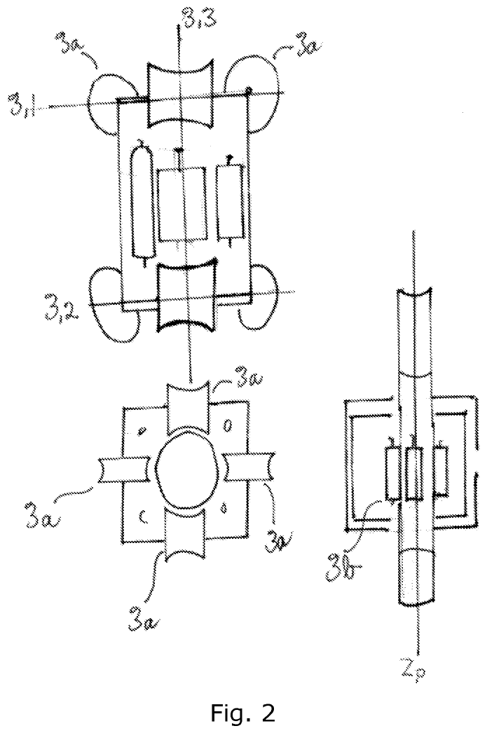

FIG. 2 is a side view of the gearbox lb, where the gearbox contains two planes 3,1 and 3,2 with each four gearwheels 3a, and the plane 3,3 which is perpendicular to the planes 3,1 and 3,2 and goes through the centre axis Zp of the pile rack.

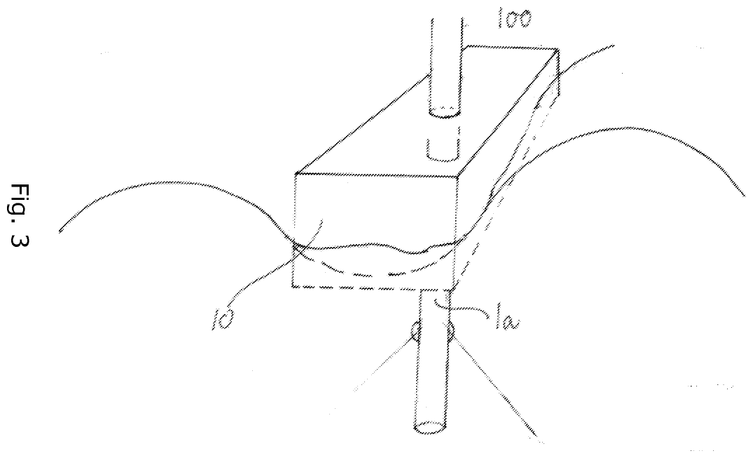

FIG. 3 shows how the pile rack la may be incorporated in a wave power plant 100 with a floating element 10 which is affected by the waves and surrounds the pile rack la. The pile rack may be fastened to a seabed or other element/body, e.g. with a wire, chain or rod. When the waves are moving the floating element up and down the pile rack la, the linear movement will be transmitted to the gear wheels which are in mesh with the pile rack. The rotating movement of the gear wheels may in turn be transferred to a generator.

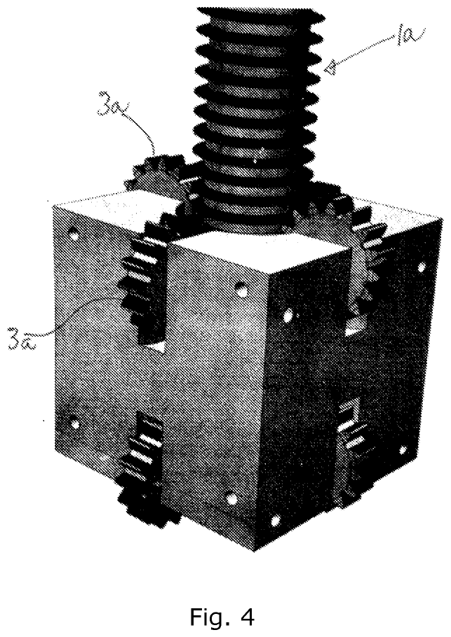

FIG. 4 is a perspective view of a gearbox lb in engagement with a pile rack la, where the gearbox lb contains a total of eight gear wheels 3a with each four gear wheels 3a in two planes. The object of this solution is primarily to stabilize/control the gear box relatively the pile rack.

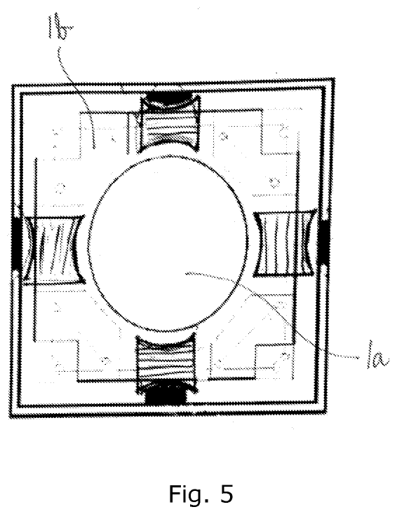

FIG. 5 is a sketch showing an embodiment of the wave power plant with a pile rack la, surrounded by a gearbox lb with four gear wheels 3a, where the gearbox is fixed in a floating element 10, where the floating element is gyro-stabilized attached to the gearbox lb.

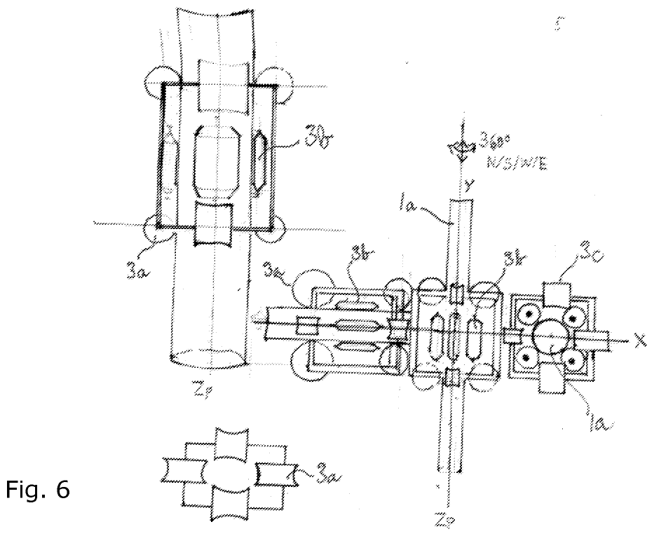

FIG. 6 shows a gearbox lb with one vertical through-going guide-hole and one horizontal through-going guide-hole, mounted side by side. Where one gearbox provides a linear horizontal direction of motion (x) and where a second gearbox provides linear vertical motion (y). In this way the gearboxes lb can simultaneously move in two axial directions with a rotation determined by the elongated gear wheel (one or more elongated gear wheels) which then controls this function. The vertically mounted gearbox will also have the same function, and will work in one unit or several systems of gearboxes.

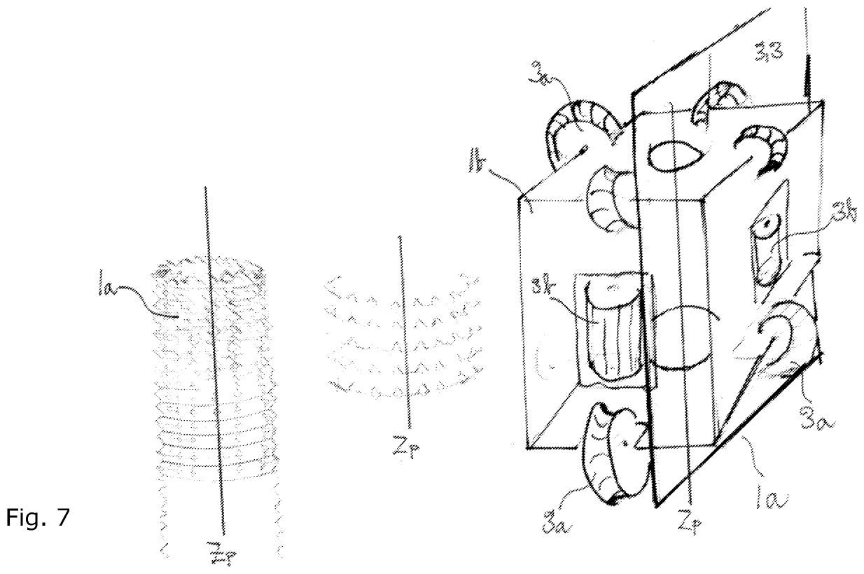

FIG. 7 shows a gearbox with one or more elongated gear wheels 3b, arranged around the pile rack la, and forming a planet gear with the pile rack l a plane 3,3, and wherein the axis of rotation of the elongated gearwheel(s) is in parallel with the centre axis Zp of the pile rack and which will engage at least one of the pile rack teeth. The elongated gear wheels 3b are in engagement with longitudinal grooves in the axial direction Zp of the pile rack.

Assuming that the gearbox lb is fixedly mounted relative to the pile rack la, it will be able to rotate the gear wheel having a rotation axis in parallel with the pile rack la if said pile rack is applied rotational forces from one or more motors attached to the gearbox, and/or that the vertical gear wheel 3b will rotate or stand still after applying forces via the pile rack. Thus, the gearbox, eventually with a floating element, may be oriented in the horizontal plane. In this way, the floating element, which may have an elongated shape, may be aligned relative the direction of the waves.

All power and signal cables can be passed through the pile rack and/or with slip rings.

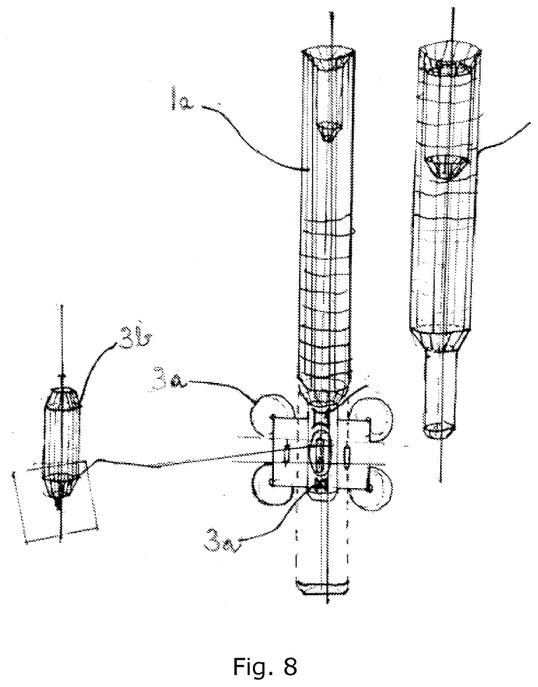

FIG. 8 shows a gearbox centring which, through the coupling of a two-piece or multi-part pile rack of conical design in the entrance area h secures the gearbox and pile rack against damage during assembly and connection. Here, both the pile rack and one or more vertically-positioned steering gear wheels may have a conical shape in the entrance area.

Incidentally, by assembling two gearboxes as with the gearbox centring, it will transfer its gear to the second pile rack. This is not shown in the figures.

Even if each figure shows details of different embodiments, it is possible to combine features from each embodiment, for example in a wave power plant.

1. A device (1) for converting a linear motion into a rotary motion, characterized in that the device comprises:
a cylindrical pile rack (la), with teeth axially arranged around the entire pile throughout its longitudinal axis (Zp), and
at least one gearbox (lb) comprising:
four gears wheels (3) rotatably arranged around their own axis of rotation perpendicular to the centre axis of the pile rack (la) and engaging in the pile of a first plane (3,1), the gear wheels (3) having arcuate teeth and adapted to the radius of the pile (la) and wherein the gearbox (lb) with the gears (3) is further rotatably arranged around the centre axis of the pile rack (Zp) so that the gear wheels guide and centre the pile rack (la) as the gearbox moves linearly with respect to the pile rack and/or about the pile rack (la).

2. A device (1) according to claim 1, wherein the pile rack (la) is divided radially into at least two parts and interconnected, where the interconnection provides a seamless and continuous pile rack.

3. A device (1) according to claim 1, wherein the gearbox (lb) further comprises at least two gear wheels (3), pivotally arranged around its own rotational axis and engaging the gearbox (la) in a second plane (3,2) of the gearbox (lb).

4. A device (1) according to claim 1, wherein the gearbox (lb) further comprises a plurality of sets of at least two gear wheels (3), pivotally arranged around their own rotational axis and engaging the pile rack (la) in several planes.

5. A device (1) according to claim 1, wherein all the teeth of the pile rack (la) further comprise radially arranged and evenly spaced gears grooved phased in the axially arranged racks and running parallel to the centre axis of the ratchet rod (la) for all or part of its length.

6. A device (1) according to claim 5, wherein the gearbox (lb) further comprises at least one sprocket arranged in a spaced axis of rotation parallel to the centre axis (Zp) of the pile rack (la) forming a planetary gear with the pile rack in a plane (3,3).

7. A device (1) according to claim 1, wherein the device comprises a pile rack (la) and two gearboxes (lb).

8. A device (1) according to claim 1, wherein the gear wheels (3) of the gearbox(es) are connected by one or more means (7, 8) selected from: wheel axles, angular joints, angled gears, cardans.

9. A device (1) according to claim 1, wherein the gear wheels (3) of the gearbox(es) can each be coupled with at least one generator and/or at least one motor.

10. A wave power plant (100) comprising a device according to claim 1, further comprising a floating element (10).

11. A wave power plant (100) according to claim 10, wherein at least one gearbox (lb) is mounted in the floating element (10) with gear exchange to generators.

12. A wave power plant (100) according to claim 11, wherein the energy transmitted via the gearbox can be transmitted to gears, shafts, pressure systems, hydraulics, and/or chain drive.

13. A wave power plant (100) according to claim 10, wherein the pile rack (la) is anchored to a seabed, or to any fixed element.

14. A wave power plant (100) according to claim 11, wherein the gearbox (lb) is mounted in, on or below the floating element (10).

15. A wave power plant (100) according to claim 10, wherein the floating element (10) comprises a gyro connected to the floating element in a first side and which is further coupled to a gearbox in a second side.
